(19) United States
(12) Patent Application Publication
(10) Pub. No.: US 2016/0076578 A1
(43) Pub. Date: Mar. 17, 2016

(54) NUT ANTI-ROTATION CAP

(71) Applicant: General Electric Company, Schenectady, NY (US)

(72) Inventors: Mark Carmine Bellino, Greenville, SC (US); Heath Michael Ostebee, Easeley, SC (US); Lucas John Stoia, Taylors, SC (US); Christopher Paul Willis, Pickens, SC (US)

(21) Appl. No.: 14/485,296

(22) Filed: Sep. 12, 2014

(51) Int. Cl. F16B 39/08

(52) U.S. Cl. CPC F16B 39/08

(57) ABSTRACT

A nut anti-rotation cap includes an end wall having an inner surface configured to be operatively coupled to an end of a threaded mechanical fastener. Also included is at least one sidewall extending from the end wall, wherein the at least one sidewall is a solid wall configured to be secured to a nut engaged with the threaded mechanical fastener and to enclose an exposed portion of the threaded mechanical fastener.

### BACKGROUND OF THE INVENTION

The subject matter disclosed herein relates to threaded mechanical fasteners and, more particularly, to a nut anti-rotation cap associated with threaded mechanical fasteners.

Nuts and threaded members, such as bolts, are employed to fasten a wide variety of machine components. In many applications, however, operation of the machine causes vibrational or other stresses on the threaded member assembly, which may result in loosening or loss of the nut. In such applications, devices may be employed to retain the nut on the threaded member, preventing its loosening or loss. Such devices typically require inclusion with the threaded member assembly stock or fixed attachment to the nut or threaded member, causing damage to either or both and preventing their reuse after disassembly. For example, many such devices require that the threaded member be cut in order to disassemble the threaded member assembly, requiring replacement of the entire assembly.

This process can become quite expensive in applications where the nut and threaded member assemblies are themselves expensive, such as in gas turbine applications. This expense is exacerbated where periodic or frequent disassembly and reassembly of the nut and threaded member assembly is required, such as, for example, machine maintenance or the replacement of machine parts. Each disassembly requires destruction of the nut and threaded member assembly in place and replacement with a new nut and threaded member assembly, to which a new retention device is then applied.

In addition, some applications simply require a greater degree of retentive strength and/or additional points of retention. For example, nut and threaded member assemblies employed in gas turbine applications, particularly in connection with gas turbine combustion components such as the mounting of combustion transition pieces in a gas turbine, are subjected to high stresses during operation of the gas turbine. This situation requires not only a greater degree of retention, but often the use of very strong, expensive nut and threaded member assemblies. While the use of nut retention devices is often necessary in such situations, the destruction of such expensive nut and threaded member assemblies each time disassembly is required greatly increases the cost of operation of the gas turbine.

### BRIEF DESCRIPTION OF THE INVENTION

According to one aspect of the invention, a nut anti-rotation cap includes an end wall having an inner surface configured to be operatively coupled to an end of a threaded mechanical fastener. Also included is at least one sidewall extending from the end wall, wherein the at least one sidewall is a solid wall configured to be secured to a nut engaged with the threaded mechanical fastener and to enclose an exposed portion of the threaded mechanical fastener.

According to another aspect of the invention, a nut retention assembly includes a threaded mechanical fastener. Also included is a nut engaged with the threaded mechanical fastener. Further included is a nut anti-rotation cap having an end wall welded to the threaded mechanical fastener and a cylindrical sidewall extending from the end wall, wherein an inner sidewall surface geometry corresponds to an outer geometry of the nut, wherein the cylindrical sidewall is a solid wall configured to be secured to the nut to prevent rotation of the nut.

According to yet another aspect of the invention, a gas turbine engine includes a first component and a second component. Also included is a threaded mechanical fastener extending through the first component and the second component. Further included is a nut engaged with the threaded mechanical fastener to secure the first component to the second component. Yet further included is a nut anti-rotation cap having an end wall welded to the threaded mechanical fastener and a cylindrical sidewall extending from the end wall, wherein an inner sidewall surface geometry corresponds to an outer geometry of the nut, wherein the cylindrical sidewall is a solid wall configured to be secured to the nut to prevent rotation of the nut.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a gas turbine engine;

FIG. 2 is a cross-sectional view of a nut retention assembly; and

FIG. 3 is a perspective view of a nut anti-rotation cap of the nut retention assembly.

The detailed description explains embodiments of the invention, together with advantages and features, by way of example with reference to the drawings.

### DETAILED DESCRIPTION OF THE INVENTION

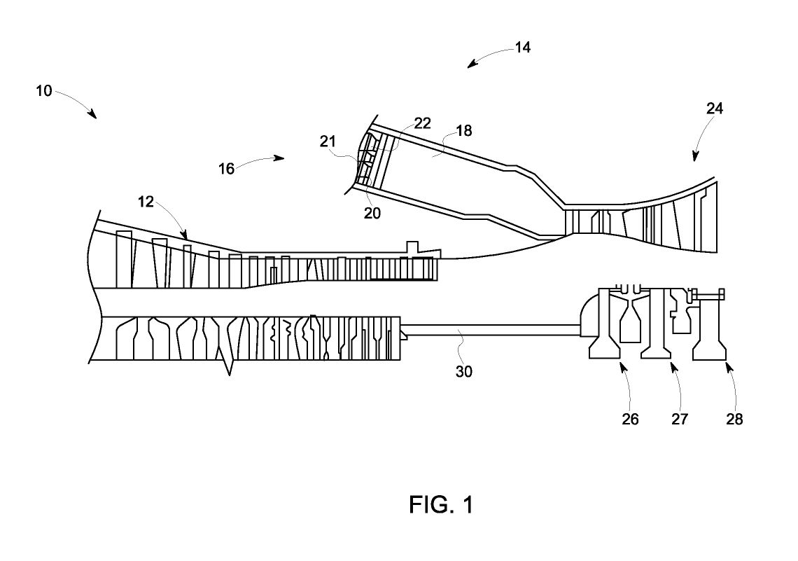

Referring to FIG. 1, a turbine system, such as a gas turbine engine 10, constructed in accordance with an exemplary embodiment of the present invention is schematically illustrated. The gas turbine engine 10 includes a compressor section 12 and a plurality of combustor assemblies arranged in a can annular array, one of which is indicated at 14. The combustor assembly is configured to receive fuel from a fuel supply (not illustrated) through at least one fuel nozzle 20 and a compressed air from the compressor section 12. The fuel and compressed air are passed into a combustor chamber 18 defined by a combustor liner 21 and ignited to form a high temperature, high pressure combustion product or air stream that is used to drive a turbine 24. A transition piece may be disposed between the combustor chamber 18 and the turbine 24, with the transition piece being a separate component or integrally formed with the combustor assembly to form a single uniform body. The turbine 24 includes a plurality of stages 26-28 that are operationally connected to the compressor 12 through a compressor/turbine shaft 30 (also referred to as a rotor).

In operation, air flows into the compressor 12 and is compressed into a high pressure gas. The high pressure gas is supplied to the combustor assembly 14 and mixed with fuel, for example natural gas, fuel oil, process gas and/or synthetic gas (syngas), in the combustor chamber 18. The fuel/air or combustible mixture ignites to form a high pressure, high temperature combustion gas stream, which is channeled to the turbine 24 and converted from thermal energy to mechanical, rotational energy.

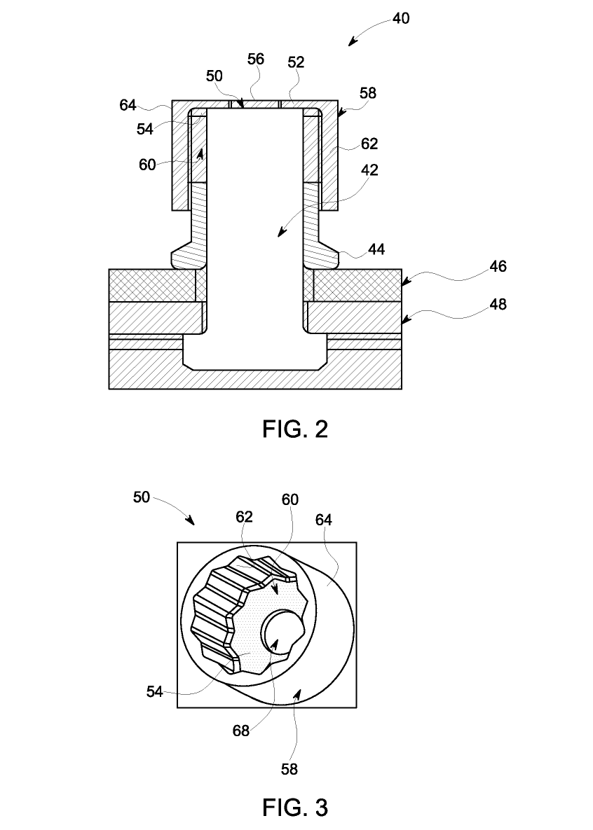

Referring to FIG. 2, a nut retention assembly 40 is illustrated in a cross-sectional manner. The nut retention assembly 40 includes a threaded mechanical fastener 42, such as a bolt, stud, screw, or the like, and a nut 44 configured to be operatively coupled to the threaded mechanical fastener 42 in threaded engagement. The threaded mechanical fastener 42 and the nut 44 are employed to secure two or more components together. The illustrated embodiment generically depicts a first component 46 and a second component 48 that may form or be part of an overall assembly. The first component 46 and the second component 48 may be part of the gas turbine engine 10 described in detail above. In one embodiment, the nut retention assembly 40 is used to secure components of a transition piece of the gas turbine engine 10, however, any components or sub-systems of the gas turbine engine 10 that require mechanical fastening may benefit from the embodiments of the nut retention assembly 40 described herein.

To prevent rotation of the nut 44 while it is subjected to operating conditions of the system that it is employed in, a nut anti-rotation cap 50 (FIG. 3) is included in the nut retention assembly 40. The nut anti-rotation cap 50 includes an end wall 52 having an inner surface 54 and an outer surface 56. Extending from the end wall 52 is at least one sidewall 58. The at least one sidewall 58 is typically a substantially cylindrical solid wall, however, it is contemplated that alternative geometries and more than one wall is employed to define an inner cavity 60. The at least one sidewall 58 includes an inner sidewall surface 62 and an outer sidewall surface 64. At least a portion of the inner sidewall surface 62 is formed to have an inner sidewall surface geometry that corresponds to an outer geometry of the nut 44. In this manner, the nut anti-rotation cap 50 is directly placed over the nut 44 in tight fitted engagement.

As can be appreciated, numerous contemplated geometries of the corresponding geometry of the inner sidewall surface 62 and the nut 44 would facilitate the fitted engagement described above. An exemplary, but not exhaustive list of geometries includes a hexagonal geometry and a 12-point geometry.

In addition to, or alternatively, the tight fitted engagement of the nut anti-rotation cap 50 and the nut 44 may be established by other mechanical joining methods. For example, a pin or the like may be inserted through the at least one sidewall 58 and the nut 44 to facilitate securing the nut anti-rotation cap 50 and the nut 44.

The end wall 52 of the nut anti-rotation cap 50 is formed of a “weldable” metal, such as steel or a nickel-based allow, for example. However, as used herein, “weldable” is intended to encompass materials that may be joined to one or more other components, such as by metal welding, melting, and chemical dissolution, for example. In some embodiments, the entire nut anti-rotation cap 50 is formed of such a material. Typically, the same material is used for the end wall 52 and the at least one sidewall 58.

To facilitate anti-rotation of the nut 44 relative to the threaded mechanical fastener 42, the nut anti-rotation cap 50 is operatively coupled to the threaded mechanical fastener 42. In one embodiment, the end wall 52 is welded to an end of the threaded mechanical fastener 42. In some embodiments, the end wall 52 includes a hole 68 that provides an access point for the welding process. This coupling aspect (e.g., welding) of the end wall 52 to the end of the threaded mechanical fastener 42, combined with the tight fitted engagement of the at least one sidewall 58 with the nut 44, ensures that the nut 44 will not rotate relative to the threaded mechanical fastener 42. By welding the nut anti-rotation cap 50 to the end of the threaded mechanical fastener 42 (i.e., not welded to the threaded portion), removal of the nut anti-rotation cap 50 does not require destruction of the threaded portion of the fastener, thereby allowing the threaded mechanical fastener 42, the nut 44 and the nut anti-rotation cap 50 to be reused. The ability to reuse these components advantageously provides an immediate economic benefit by reducing the number of replacement parts.

In certain applications, the operating environment of the nut retention assembly 40 leads to damage to the threaded mechanical fastener 42. An example of such damage is in the form of oxidation that degrades the threaded mechanical fastener 42 over time. To reduce the effects harsh operating conditions, direct exposure of the threaded mechanical fastener 42 is alleviated by fully encasing an outer perimeter of the threaded mechanical fastener 42 within the inner cavity 60 of the nut anti-rotation cap 50.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A nut anti-rotation cap comprising:
an end wall having an inner surface configured to be operatively coupled to an end of a threaded mechanical fastener; and
at least one sidewall extending from the end wall, wherein the at least one sidewall is a solid wall configured to be secured to a nut engaged with the threaded mechanical fastener and to enclose an exposed portion of the threaded mechanical fastener.

2. The nut anti-rotation cap of claim 1, wherein the inner surface of the end wall is welded to the end of the threaded mechanical fastener.

3. The nut anti-rotation cap of claim 1, wherein the at least one sidewall is a cylindrical wall.

4. The nut anti-rotation cap of claim 1, wherein the at least one sidewall includes an inner sidewall surface geometry corresponding to the nut engaged with the threaded mechanical fastener.

5. The nut anti-rotation cap of claim 4, wherein the inner sidewall surface geometry is a hexagonal geometry.

6. The nut anti-rotation cap of claim 4, wherein the inner sidewall surface geometry is a 12-point geometry.

7. The nut anti-rotation cap of claim 1, wherein the at least one sidewall is secured to the nut with at least one pin.

8. The nut anti-rotation cap of claim 1, further comprising a hole defined by the end wall.

9. The nut anti-rotation cap of claim 1, wherein the nut anti-rotation cap is part of a mounting system of a component of a gas turbine.

10. The nut anti-rotation cap of claim 9, wherein the nut anti-rotation cap is configured to be used in a transition piece of the gas turbine.

11. A nut retention assembly comprising:
a threaded mechanical fastener;
a nut engaged with the threaded mechanical fastener; and
a nut anti-rotation cap having an end wall welded to the threaded mechanical fastener and a cylindrical sidewall extending from the end wall, wherein an inner sidewall surface geometry corresponds to an outer geometry of the nut, wherein the cylindrical sidewall is a solid wall configured to be secured to the nut to prevent rotation of the nut.

12. The nut retention assembly of claim 11, wherein the threaded mechanical fastener is a bolt.

13. The nut retention assembly of claim 11, wherein the threaded mechanical fastener is a stud.

14. The nut retention assembly of claim 11, wherein the inner sidewall surface geometry is a hexagonal geometry.

15. The nut retention assembly of claim 11, wherein the inner sidewall surface geometry is a 12-point geometry.

16. The nut retention assembly of claim 11, wherein the cylindrical sidewall is secured to the nut with at least one pin.

17. The nut retention assembly of claim 11, further comprising a hole defined by the end wall.

18. The nut retention assembly of claim 11, wherein the nut anti-rotation cap is part of a mounting system of a component of a gas turbine.

19. The nut retention assembly of claim 18, wherein the nut anti-rotation cap is configured to be used in a transition piece of the gas turbine.

20. A gas turbine engine comprising:
a first component;
a second component;
a threaded mechanical fastener extending through the first component and the second component;
a nut engaged with the threaded mechanical fastener to secure the first component to the second component; and
a nut anti-rotation cap having an end wall welded to the threaded mechanical fastener and a cylindrical sidewall extending from the end wall, wherein an inner sidewall surface geometry corresponds to an outer geometry of the nut, wherein the cylindrical sidewall is a solid wall configured to be secured to the nut to prevent rotation of the nut.
